(19) United States
(12) Patent Application Publication
(10) Pub. No.: US 2009/0224069 A1
(43) Pub. Date: Sep. 10, 2009

(54) Hose Assembly

(76) Inventor: Ting-I Lin, Chan-Hwa (TW)

Correspondence Address: LIN & ASSOCIATES INTELLECTUAL PROPERTY, INC., P.O. BOX 2339, SARATOGA, CA, 95070-0339, US

(21) Appl. No.: 12/043,963

(22) Filed: Mar. 7, 2008

(51) Int. Cl. A01G 27/00

(52) U.S. Cl. 239/145

(57) ABSTRACT

A hose assembly includes an inner tube having a ridge spirally extending from an outer periphery thereof and a plurality of slits are defined through the inner tube. An outer tube is wrapped around the inner tube and made by water permeable material so that water coming from the slits can permeate through a wall of the outer tube and flow into the soil.

### BACKGROUND OF THE INVENTION

1. Field of the Invention

The present invention relates generally to a hose assembly having an inner tube and an outer tube, in which the inner tube includes slits and the outer tube is made by water permeable material.

2. The Prior Arts

A conventional way to water plants is generally to use a sprinkler or hose manually to damp the soil around the plants. However, the user has to water each plant and this requires a significant labor demand. When the hose is filled with water, the water pressure makes the hose stiff and move. The moving hose might hit the plants and injure the sprouts or buds. Furthermore, lack of water source is a concern when watering plants.

Some people pre-set hoses around the garden and holes are defined through the hoses so that when the water passes through the hose, the water flows out from the holes to water the plants. By this way, the users simply turn on the faucets to water certain area of the gardens without too much labor. This method has its inherent shortcoming which is that the water coming out from the holes flushes soil away and the water stream directly hits the roots of the plants. When the faucet is turned off, a suction force is generated at the holes and sucks pebbles to obstacle the holes.

The other way, as shown in FIG. 1, is to set automatic sprinkling system which includes a main pipe buried in the soil and a plurality of nozzles are connected to the main pipe by sub-pipes. The sub-pipes provide water streams to hit the nozzles which pivots back and forth to send water to the area around the nozzle.

However, the water sprinkled from the nozzles into the air may be blown away from the garden so that exceed water is needed. The range of water sprinkling is fixed and may be sprinkled on sidewalks or even the pedestrians. The exposed nozzles affect the aesthetic appearance of the garden. Besides, the system is costly and the nozzles cannot be removed. Some plants are tiny and weak, they might be hurt by strong water stream by the system.

The present invention provides a hose assembly for watering plants and the hose assembly of the present invention improves the shortcomings of the conventional watering systems and ways.

### SUMMARY OF THE INVENTION

According to the present invention, a hose assembly is provided and includes an inner tube having a ridge spirally extending from an outer periphery of the inner tube and a plurality of slits are defined through the inner tube and located between the ridge. An outer tube is wrapped around the inner tube and water coming from the slits can pass through the outer tube.

A main objective of the present invention is to provide a hose assembly, in which the outer tube is made by water permeable material, and the water permeates through the outer tube of the hose assembly so as not to damage the plants.

Another objective of the present invention is to provide a hose assembly, in which the outer tube is made by water impermeable material, and the outer tube includes holes through which water flows out therefrom. Accordingly by using the hose assembly, the water does not be wasted.

Yet another objective of the present invention is to provide a hose assembly, in which there is no suction force to suck pebbles to obstruct the slits of the inner tube.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a perspective view of a conventional automatic sprinkling system;

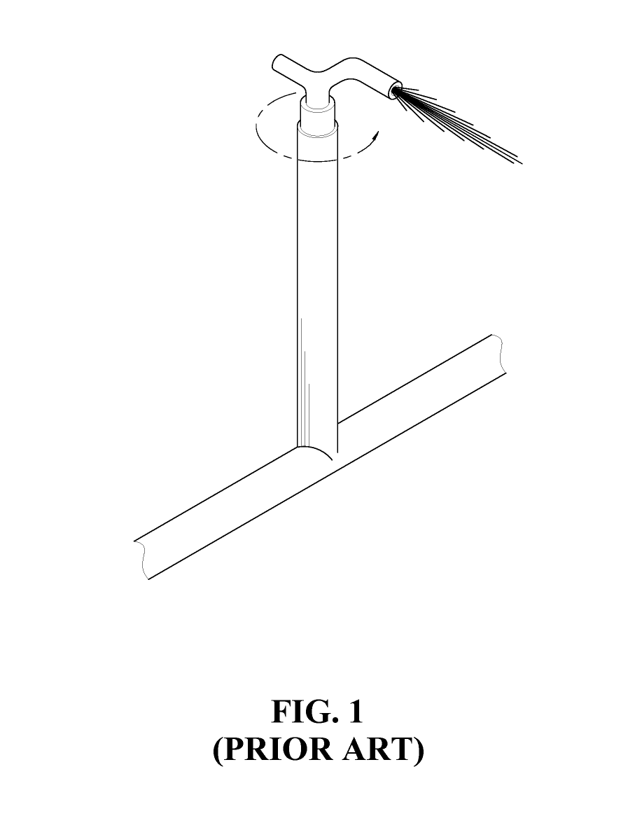

FIG. 2A shows an inner tube and an outer tube of a hose assembly in accordance with the present invention;

FIG. 2B shows another shape of slits in the inner tube;

FIG. 3 shows that the hose assembly is connected with a faucet and installed under the soil; and

FIG. 4 shows a hose assembly in accordance with another embodiment of the present invention.

### DETAILED DESCRIPTION OF THE PREFERRED EMBODIMENT

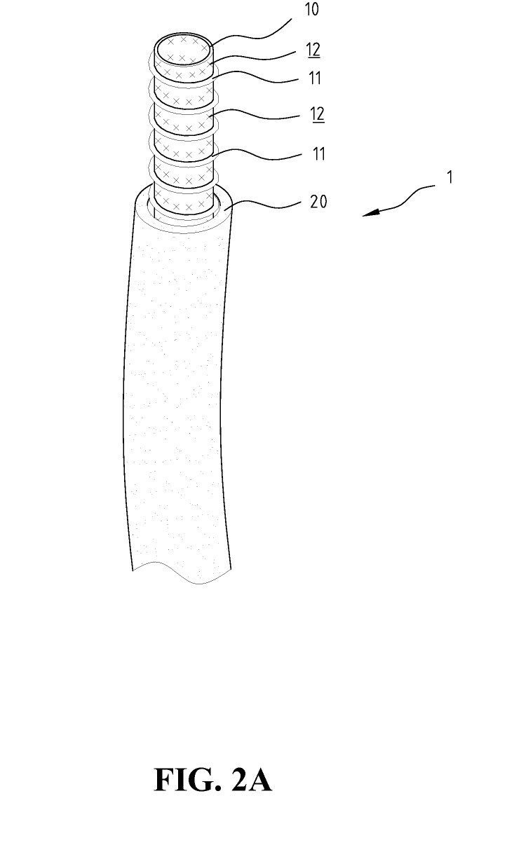

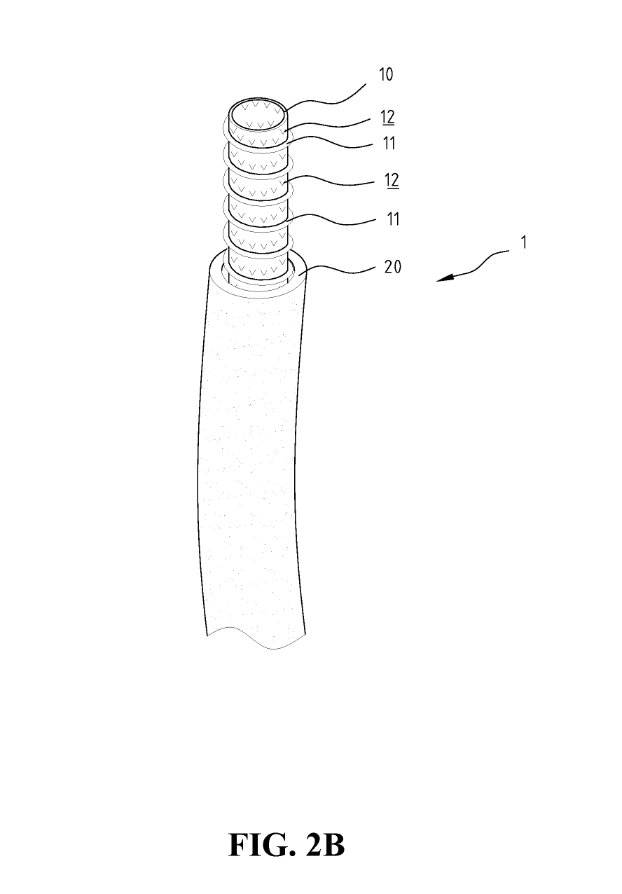

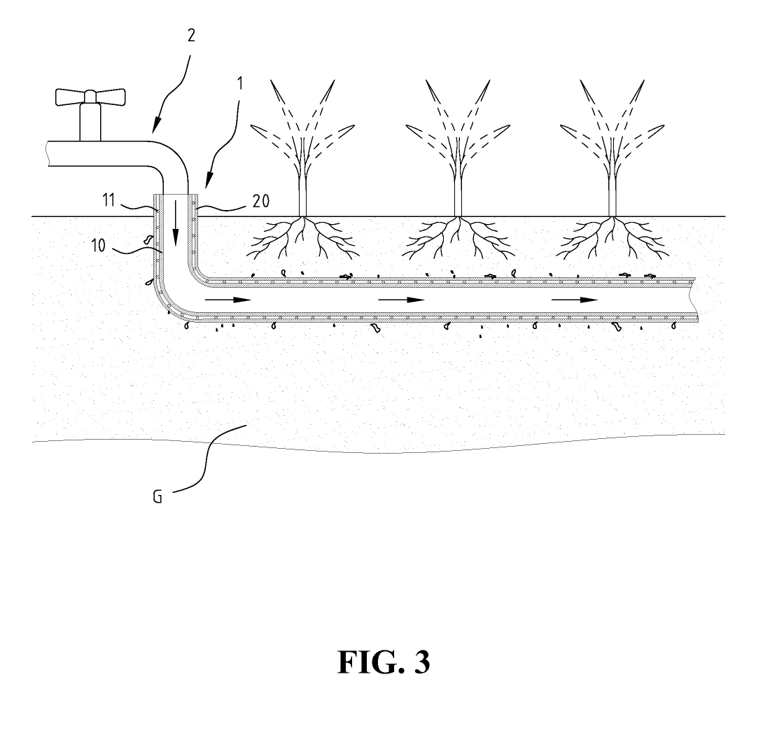

With reference to the drawings and in particular to FIGS. 2A, 2B and 3, a hose assembly 1 in accordance with the present invention comprises an inner tube 10 and an outer tube 20.

The inner tube 10 includes a ridge 11 spirally extending from an outer periphery of the inner tube 10 so as to reinforce the structural strength of the inner tube 10. A plurality of slits 12 are defined through the inner tube 10 and located between the ridge 11. The slits 12 each may be an X-shaped slit as shown in FIG. 2A, a V-shaped slit as shown in FIG. 2B, a straight-line slit, a U-shaped slit, serrated slit or any shape of slit. Water can pass through the slits 12 which are opened according to the water pressure. The larger the water pressure is, the larger the slits 12 can be opened.

The outer tube 20 is wrapped around the inner tube 10, in which water flowing in the inner tube 10 can pass through the slits 12 of the inner tube 10 and then a wall of the outer tube 20. The outer tube 20 is made by water permeable material such as woven fabric, cotton, fiber or sponge.

As shown in FIG. 3, the hose assembly 1 is installed in the soil “G” and connected with a faucet 2 which provides water into the inner tube 10. The water flows out from the slits 12 and permeates through the outer tube 20 and damps the soil “G”. By this way, the roots of the plants are not damaged by strong water streams and all of the water is absorbed by the soil.

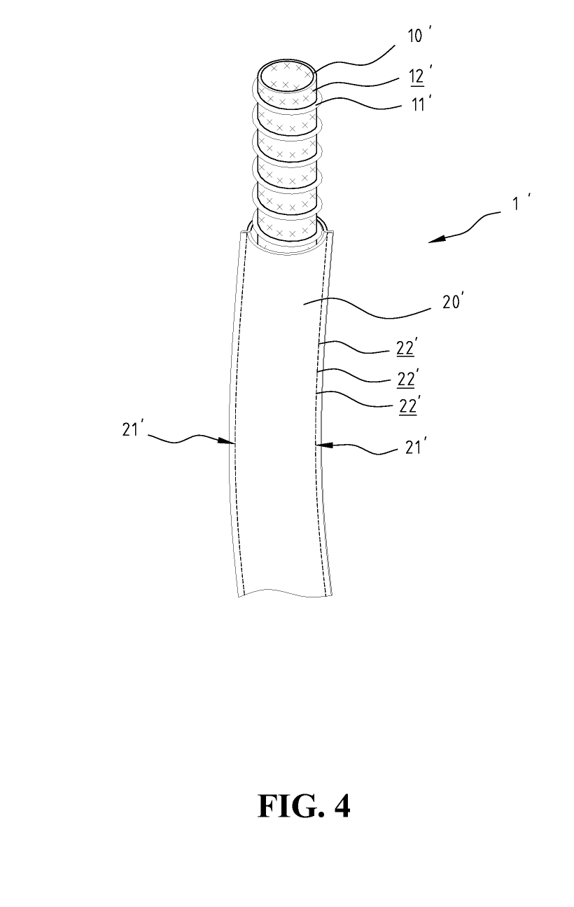

FIG. 4 shows a hose assembly 1′ in accordance with another embodiment of the present invention, which includes an inner tube 10′ with a ridge 11′ spirally extending from an outer periphery of the inner tube 10′. A plurality of slits 12′ are defined through the inner tube 10′ and located between the ridge 11′. An outer tube 20′ is wrapped around the inner tube 10′ and is made by impermeable material. At least one seam 21′ is defined in the outer tube 20′ and a plurality of holes 22′ are defined through the outer tube 20′ and located along the at least one seam 21′. The hose assembly 1′ is located in the soil “G” and water coming from the slits 12′ passes through the holes 22′ and flows into the soil “G”.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A hose assembly, comprising:
an inner tube having a ridge spirally extending from an outer periphery of the inner tube, a plurality of slits defined through the inner tube and located between the ridge; and
an outer tube wrapping around the inner tube, wherein water flowing in the inner tube is able to pass through the slits of the inner tube and then a wall of the outer tube.

2. The hose assembly as claimed in claim 1, wherein each of the slits is an X-shaped slit.

3. The hose assembly as claimed in claim 1, wherein each of the slits is a V-shaped slit.

4. The hose assembly as claimed in claim 1, wherein each of the slits is one of a straight-line slit, a U-shaped slit, or a serrated slit.

5. The hose assembly as claimed in claim 1, wherein the outer tube is made by water permeable material of woven fabric, cotton, fiber or sponge.

6. The hose assembly as claimed in claim 1, wherein the outer tube is made by water impermeable material, at least one seam is defined in the outer tube and a plurality of holes are defined through the outer tube and located along the seam.
